(19) United States
(12) Patent Application Publication
(10) Pub. No.: US 2025/0017792 A1
(43) Pub. Date: Jan. 16, 2025

(54) IMPROVED WINCH DEVICE FOR A WHEELCHAIR

(71) Applicant: ACCES ABILITY, Hallencourt (FR)

(72) Inventor: Samuel DUMEIGE, Hallencourt (FR)

(73) Assignee: ACCES ABILITY, Hallencourt (FR)

(21) Appl. No.: 18/712,672

(22) PCT Filed: Dec. 1, 2022
(86) PCT No.: PCT/FR2022/000127

§ 371 Date: May 22, 2024

(30) Foreign Application Priority Data
Dec. 1, 2021 (FR) FR2112806

(51) Int. Cl. A61G 3/08

(52) U.S. Cl. CPC A61G 3/0808

(57) ABSTRACT

The winch device (1) for a wheelchair has a drive means (3), a drum (21) for winding/unwinding of a strap, the drum being driven in rotation by the drive means, and a ratchet wheel (10a, 10b) fixed coaxially to the drum, the ratchet wheel being associated with a pawl (40), and automatic means (43, 20, 11, 30, 47) of disengagement/re-engagement of the pawl and the ratchet wheel.

### TECHNICAL FIELD OF THE INVENTION

The invention relates to the field of winch devices for wheelchairs wherein a person with reduced mobility is seated. In particular, the invention relates to an improved winch device for a wheelchair intended to equip a vehicle adapted to receive a wheelchair with a person sitting on it.

### PRIOR ART

Generally speaking, in order to install a person with reduced mobility or a patient in a wheelchair on a floor located at a certain height from the ground, it is necessary to use an access ramp between the ground and the floor. Ideally, the access ramp has an incline of around 12° to the ground. This provides a good compromise between the space occupied by the access ramp and the stretcher-bearer or ambulance driver needed to lift the wheelchair and its occupant up the ramp. The same applies for the descent.

Document FR3019036A1 describes such an access ramp system wherein the access ramp slides and, in the folded position, forms the floor of the transport vehicle. A winch winding a strap with a hook that attaches to the wheelchair structure is used to pull the wheelchair, with a person seated, onto the access ramp and then into the transport vehicle. The wheelchair with the seated person must then be secured in the transport vehicle by, on the one hand, strapping the seated person to the wheelchair and, on the other hand, securing the wheelchair in the vehicle at four points around the wheelchair: two tie-down points in front and two tie-down points behind the wheelchair. For the two front tie-down points, this requires lateral access on either side of the wheelchair, so that the stretcher-bearer or ambulance driver can secure them. This operation significantly extends the loading time before transporting the wheelchair with a seated person, as well as its unloading after transport.

According to another existing solution, the wheelchair winch has two front reels for securing the wheelchair, with a drive motor in the middle common to both reels to provide mechanical assistance up and/or down the access ramp. This has the disadvantage of requiring a great deal of handling in order to ensure the tie-downs and to secure the winch to the wheelchair. Furthermore, installation of the winch requires additional space, which is not always available in the vehicles designed to accommodate it.

A winch and tie-down assembly with two strap reels at each end of a single motorized spindle has been proposed to keep the wheelchair in line when ascending and/or descending the access ramp. Such an assembly requires a lot of space in the vehicle, and in many cases there is insufficient space for it to be installed.

### DISCLOSURE OF THE INVENTION

One aim of the invention is to provide a winch device for a wheelchair in which a person is seated, enabling loading and unloading times to be reduced, while ensuring complete safety during transport of the person thus seated in the wheelchair.

To this end, the invention provides a winch device for a wheelchair comprising a drive means, a drum for winding/unwinding of a strap, the drum being driven in rotation by the drive means, as well as a ratchet wheel fixed coaxially to one end of the drum, the ratchet wheel being associated with a pawl, and means for automatically disengaging the pawl from the ratchet wheel.

Advantageously, but optionally, the winch device according to the invention has at least one of the following technical features:
[symbol] [symbol] The winch device comprises a second ratchet wheel coaxially fixed to another end of the drum, the second ratchet wheel cooperating with the pawl;
[symbol] [symbol] The disengagement/re-engagement means comprise a compression spring and/or an electromagnet;
[symbol] [symbol] The disengagement/re-engagement means comprise a disengagement finger attached to the pawl;
[symbol] [symbol] The disengagement/re-engagement means comprise a drive wheel driven by the drive means, and a series of rollers driven by the drive wheel and driving the ratchet wheel, each roller being arranged to change, according to a direction of rotation of the drive and ratchet wheels, between centripetal and centrifugal positions;
[symbol] [symbol] Each roller cooperates with an associated radial slot in the drive wheel and an associated curved slot in the ratchet wheel;
[symbol] [symbol] In the centrifugal position, the rollers press and roll on the disengagement finger, tilting it, which disengages the ratchet wheel pawl;
[symbol] [symbol] The drive means is a motor driving the drum via a gearbox;
[symbol] [symbol] The ratchet is a tilting plate;
[symbol] [symbol] The winch device also includes compensation means located at a free end of the strap; and,
[symbol] [symbol] The winch device comprises a motor control and drive unit arranged to synchronously drive a second winch device having at least one of the above technical features.

### BRIEF DESCRIPTION OF THE FIGURES

Further features and advantages of the invention will become apparent from the following description of one embodiment of the invention. Attached drawings:

FIG. 1a and

FIG. 1b are schematic top and side views respectively of loading/unloading a wheelchair occupied by a person along an access ramp between the ground and a floor located at height above the floor;

FIG. 2 is a three-dimensional rear view of a winch device according to the invention in a strap unwinding configuration;

FIG. 3 is a three-dimensional front view of the device shown in FIG. 2;

FIG. 4 is a detailed view of detail IV in FIG. 3;

FIG. 5 is a three-dimensional view of the drive wheel and a roller of the device shown in FIG. 2; and,

FIG. 6a and

FIG. 6b are partial three-dimensional views of the winch device according to the invention in a strap winding configuration.

For greater clarity, identical or similar elements are identified by identical reference signs throughout the Figures.

Furthermore, in the description and claims, the term “winch device” also covers strap winders/unwinders.

### DETAILED DESCRIPTION OF AN EMBODIMENT

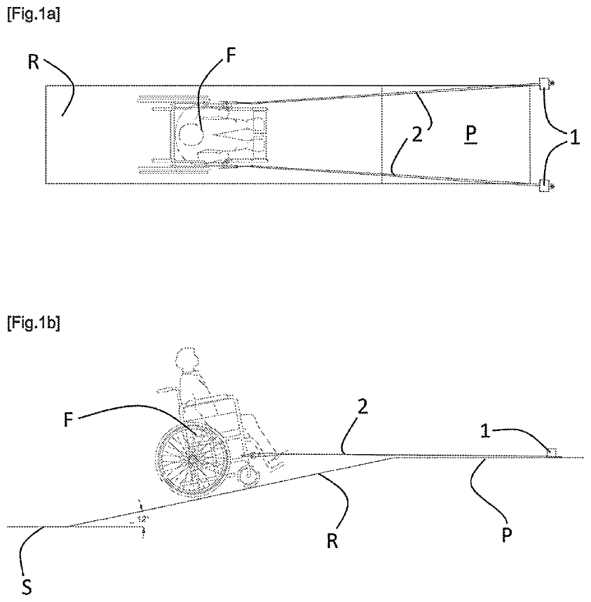

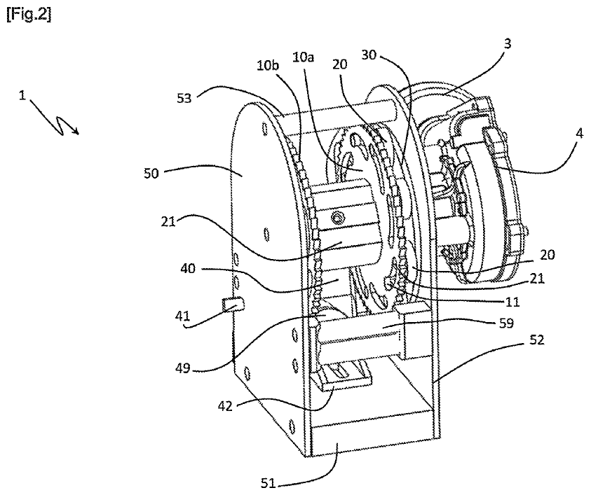

With reference to FIGS. 1a to 1b, a description will be provided of an example of the use of a winch device 1 for a wheelchair according to the invention. In this example of use, a wheelchair F has a person sitting in it. This person may be a patient or a person with reduced mobility. A floor P is represented by a substantially horizontal line and represents the floor of a vehicle fitted out for transporting a person seated in a wheelchair. The floor P generally extends substantially parallel to, opposite and at a distance from the ground S. An access ramp R is positioned between the ground S and the floor P so as to allow loading or unloading of the wheelchair F between the two. This access ramp R therefore has an inclination to the ground S, shown here at an angle of around 12°. As indicated in the preamble to this description, the choice of this value for the angle of inclination of the access ramp R to the ground S is a compromise between the footprint of the access ramp R on the ground S and the effort required to move the wheelchair F onto said access ramp R. Other inclinations are possible without going beyond the scope of the invention.

At the level of the floor P, a set of two winch devices 1 for a wheelchair according to the invention are positioned and attached on either side at a distance from one another, symmetrically to a longitudinal axis of the access ramp R and the floor P. Of this assembly, each winch device 1 for a wheelchair according to the invention is associated with a strap 2, one free end of which comprises a hook arranged so as to hook the wheelchair R at a frame, on either side laterally of the person seated in said wheelchair R, as illustrated in FIGS. 1a and 1b. Such an arrangement of the set of two winch devices 1 for a wheelchair according to the invention makes it possible, by synchronizing the two winch devices 1 for a wheelchair according to the invention, to ensure an optimal trajectory of the wheelchair F along the access ramp F and the floor R.

Thus, when the two winch devices 1 for a wheelchair according to the invention wind up their respective strap 2, the wheelchair F, with the help of a stretcher-bearer/ambulance attendant, climbs the access ramp R from the ground S and then rolls over the floor F to a secured transport position on said floor P. Conversely, when the two winch devices 1 for a wheelchair according to the invention unwind their respective straps 2, the wheelchair F, with the help of a stretcher-bearer/ambulance attendant, leaves its secure transport position, rolling over the floor P towards the access ramp R, then descends on the latter to the ground S, where the straps 2 will be unhooked from the wheelchair frame.

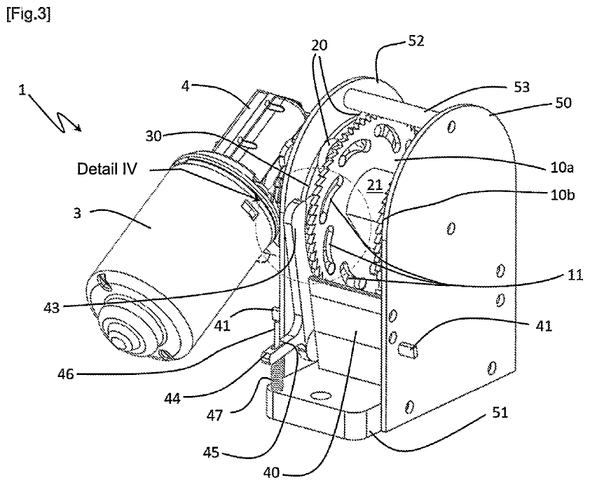

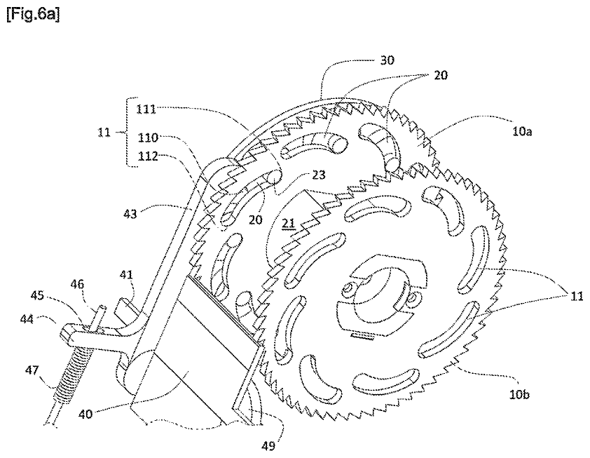

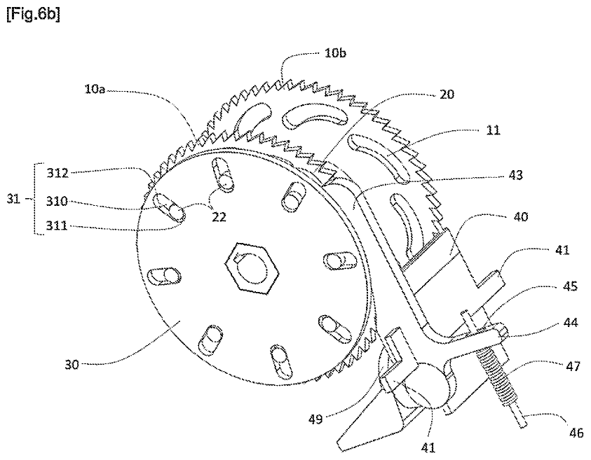

Referring now to FIGS. 2 to 6b, a description will be provided of one embodiment of the winch device 1 for a wheelchair according to the invention. It should be noted that in FIGS. 2 to 5, the winch device 1 according to the invention is in an unwinding configuration of the strap 2, and in FIGS. 6a and 6b, the winch device according to the invention is in a strap 2 winding configuration.

The winch device 1 for a wheelchair according to the invention comprises a drive means 3, here in the form of an electric drive motor. Alternatively, this drive means can be a drive spring housed in the drum means or external to it. In the embodiment shown, the electric motor is coupled to an input of a gearbox 4. For example, the input of the gearbox 4 features a worm that meshes with a pinion forming the output of gearbox 4. On the other hand, the winch device 1 for a wheelchair according to the invention further comprises an attachment framework formed here of at least a first flange 50; a second flange 52, a mounting plate 51 and a spacer 53. The first 50 and second 52 flanges run parallel, facing and at a distance from one another. They are attached at the bottom on either side of the mounting plate, and at the top to one another by the spacer 53, which has a width equal to the width of the mounting plate 51. On the outside of this frame, the gearbox 4 is attached to an external face of the second flange.

Between the first 50 and second 52 flanges, the winch device 1 for a wheelchair according to the invention comprises a drum 21 on which a strap 2 (not shown in FIGS. 2 to 5) is intended to be wound or unwound during operation of the winch device 1 for a wheelchair according to the invention. The drum 21 is framed by two ratchet wheels 10a and 10b mounted coaxially with the drum 21 and integral therewith. Between the ratchet wheel 10a and the second flange 52, the winch device 1 for a wheelchair according to the invention comprises a drive wheel 30 and a series of rollers 20 (here eight in number) evenly distributed over a circumference of the ratchet wheel 10a and sandwiched between the ratchet wheel 10a and the drive wheel 30. This forms part of the automatic disengagement/re-engagement means for the pawl 40 of the ratchet wheel 10a, 10b.

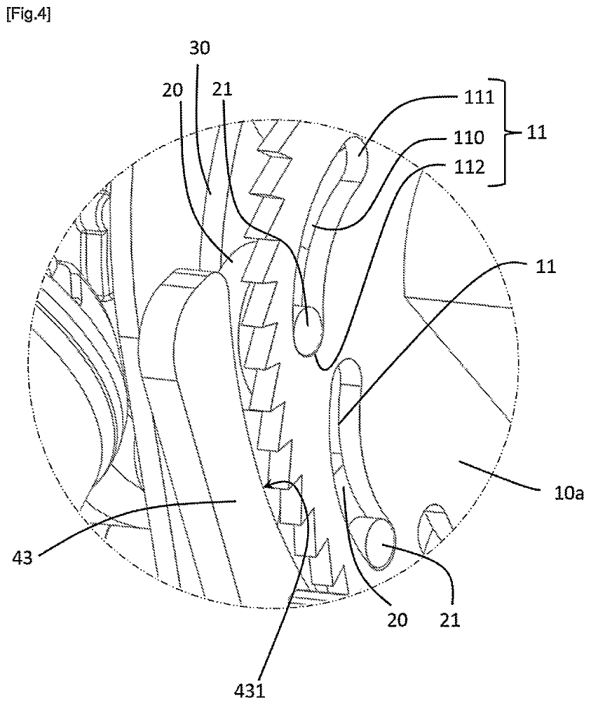

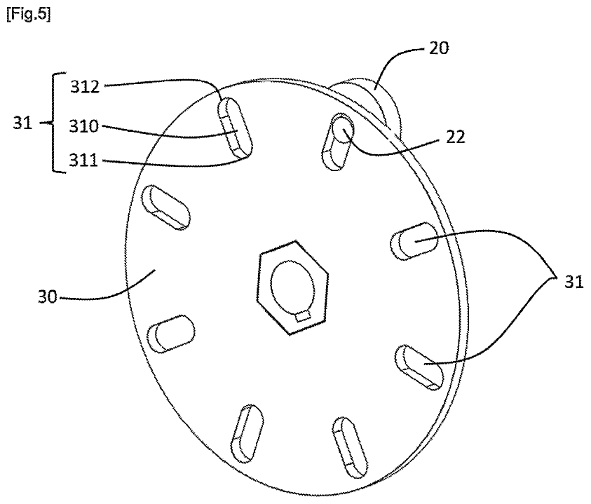

Completing this part of the disengagement/re-engagement means, at least the ratchet wheel 10a has a series of curved slots 11 of elongated bean-like shape uniformly distributed over a circumference of the ratchet wheel 10b, at a radially centripetal distance from the teeth of the ratchet wheel 10a. Here, the number of curved slots is eight. Each curved slot 11 passes through one thickness of the ratchet wheel 10a. Each curved slot 11 has a curved lumen 110 extending between two ends 111 and 112. The two ends 112 and 111 are positioned respectively on two different radii with respect to a center of the ratchet wheel 10a, as well as being angularly offset from one another. Thus, the end 112 is on a radius so as to be close to and radially below the teeth of ratchet wheel 10a, while the end 111 is on a smaller radius. The angular offset between the ends 112 and 111 is in the direction of winding rotation of the drum 21, that is, clockwise as shown in FIG. 4. The ratchet wheel 10b may be identical to the ratchet wheel 10a, or solid, or otherwise.

The drive wheel 30, best illustrated in FIG. 5, is coupled to and driven by the output of the gearbox 4. This is a solid wheel with a series of radial slots 31, of which there are eight here. Each radial slot 31 passes through one thickness of the drive wheel 30. Each radial slot 31 has an oblong slot 310 extending radially between the two ends 311 and 312. The two ends 312 and 311 are positioned respectively on two different radii with respect to a center of the drive wheel 30. More precisely, the radius where the end 312 is positioned is substantially equal to that of the end 112 of the curved slots 11. And the radius where the end 311 is positioned is substantially equal to that of the end 111 of the curved slots 11. This allows the drive wheel 30 to be mounted coaxially with the ratchet wheel 10a, while associating a curved slot 11 on the ratchet wheel 10a with a radial slot 31 on the drive wheel 30, with a roller 20 interposed between the two.

To this end, the roller 20 has a coaxial first pin 23 movable in the associated curved slot 11 of the ratchet wheel 10a, and a coaxial second pin 22 movable in the associated radial slot 31 of the drive wheel 30. The first 23 and second 22 coaxial pins extend on either side of the roller 20 and extend along an axis of rotation of the latter.

The winch device 1 for a wheelchair according to the invention further comprises a pawl 40 that simultaneously cooperates with the two ratchet wheels 10a and 10b. It takes the form of a plate mounted between the first 50 and second 52 flanges, pivoting about a pivot axis 41. To ensure cooperation between the pawl 40 and the teeth of the ratchet wheels 10a and 10b, two systems are provided which can be associated and form part of the means for automatic disengagement/re-engagement of the pawl 40 from the ratchet wheel 10a, 10b.

The first system is an electromagnet 49, shown in FIG. 2, attached on one side to the mounting plate 51 via a bracket 49 and acting on the other side on the pawl 40 by tilting it towards or away from the teeth of the ratchet wheels 10a and 10b.

The second system, shown in FIG. 3, is an extension 44 attached to the pawl 40, at the free end of which is a through-hole 45. Through this hole 45 passes a rod 46 anchored in the mounting plate 51 and extending perpendicularly from an upper face of the mounting plate 51, a compression spring 47 being positioned on the rod 46 compressed between the extension 44 and the mounting plate 51.

On the other hand, the pawl 40 has a disengagement finger 43 extending along a lateral side of the plate forming the pawl 40 and facing the rollers 20. The disengagement finger 43 comprises a rolling surface 431 facing the rollers 20, rolling surface 431 on which the rollers 20 can roll and press.

Finally, the winch device 1 for a wheelchair according to the invention comprises a strap guide 59, parallel to the drum 21 and positioned between the first 50 and second 52 flanges. This belt guide 59 guides the belt 2 as it winds/unwinds on the drum 21.

The operation of the winch device 1 for a wheelchair according to the invention will now be described.

The drive wheel 30 is driven by the motor 3 via the gearbox 4. The drive wheel 30 drives the series of rollers 20 in rotation, via their second coaxial pin 22 cooperating with the series of radial slots 31. The series of rollers 20 then drives the ratchet wheel 10a (and incidentally the drum 21 and the other ratchet wheel 10b) via their first coaxial pin 23 cooperating with the series of curved slots 11.

The pawl 40 is forced, in the clockwise direction of rotation of the ratchet wheels 10a and 10b (that is, the direction of winding of the strap 2 onto the drum 21) by the compression spring 47, which performs the pawl function, onto the teeth of the ratchet wheels 10a and 10b. As a result, the drum 21 cannot move in a counterclockwise direction (that is, the direction in which the strap 2 is unwound from the drum 21) when the pawl 40 is engaged with a tooth on each of the ratchet wheels 10a and 10b. This configuration is illustrated in FIGS. 6a and 6b.

In particular, when the belt 2 is wound onto the drum 21, the rollers 20 are rotated in a clockwise direction and move simultaneously in the curved slots 11 and the radial slots 31 towards the ends 111 and 311 respectively to reach a centripetal position, with at least the first coaxial pin 23 abutting the end 111. In this way, the rollers 20 drive the ratchet wheel 10a in rotation. During this rotational movement, the disengagement finger 43 is out of reach of the rollers 20, which cannot press on its rolling surface 431, enabling the pawl 40 to perform its function. This is illustrated in FIGS. 6a and 6b.

Conversely, when the strap 2 is unwound from the drum 21 (as shown in FIGS. 2 to 5), the rollers 20 are driven in counter-clockwise rotation. The rollers 20 then simultaneously move back into the curved slots 11 and the radial slots 31 towards the ends 112 and 312 respectively in order to reach a centrifugal position, with at least the first coaxial pin 23 abutting the end 112. In this way, the rollers 20 drive the ratchet wheel 10a in rotation. In addition, they press, and roll, on the rolling surface 431 of the disengagement finger 43. This tilts the disengagement finger 43, driving the pawl 40 into a position where it is disengaged and away from the teeth of the ratchet wheels 10a. The pawl 40 then no longer performs its function.

The use of such a winch device 1 according to the invention enables the winch device to be unlocked without the user having to perform any additional manipulation. It also enables the power of the drive means 3 to be used to disengage the pawl 40 via the disengagement finger 43. Alternatively, while the strap 2 is being unwound, the electromagnet 49 is energized to keep the pawl 40 in the open position, that is, away from the teeth of the ratchet wheel 10a and/or 10b.

Above all, the winch device 1 according to the invention enables the wheelchair F to be secured at the front before transport, without the user having to perform any additional operations.

In order to obtain synchronization between the two winch devices 1 according to the invention driving the wheelchair F, as previously indicated with reference to FIGS. 1a and 1b, a control and drive unit is provided for the two motors 3 via, for example, Hall effect sensors positioned on the motors 3 and connected to the control and drive unit.

Alternatively, to compensate for a stretcher-bearer/ambulance attendant maneuvering the wheelchair F at the same time, compensation means are provided between the free end of the strap 2 and the associated hook. This means of compensation can be a dynamometric spring. In another variant, the compensation means is positioned in parallel with a slack portion of the free end of the strap 2. Thus, during operation, the slack portion of the strap 2 becomes progressively tauter until the slack portion is completely taut. This ensures that, when the wheelchair F is secured for transport, the strap is fully tensioned between the wheelchair 2 and its associated winch device 1 according to the invention.

The winch device 1 according to the invention is a winch device for a wheelchair F which also acts as a front tie-down for the wheelchair F during transport. The's winch device 1 according to the invention therefore enables the wheelchair F to be raised, lowered and secured in vehicles fitted with an access ramp R.

Of course, it is possible to make numerous modifications to the invention without going beyond its scope.

1. A winch device (1) for a wheelchair (F) comprising a drive means (3), a drum (21) for winding/unwinding of a strap (2), the drum being driven in rotation by the drive means, a pawl (40), a ratchet wheel (10a, 10b) fixed coaxially to one end of the drum, the ratchet wheel being associated with the pawl (40), and automatic means (43, 20, 11, 30, 31, 47; 49) of disengagement/re-engagement for automatically disengaging/reengaging the pawl from the ratchet wheel, characterized in that the disengaging/reengaging means comprise a drive wheel (30) driven by the drive means, and a series of rollers (20) driven by the drive wheel and driving the ratchet wheel (10a), each roller (20) being arranged to change, depending on a direction of rotation of the drive and ratchet wheels, between centripetal and centrifugal positions.

2. The winch device according to claim 1, characterized in that it comprises a second ratchet wheel (10b) fixed coaxially to another end of the drum, the second ratchet wheel (10b) cooperating with the pawl (40).

3. The winch device according to claim 2, characterized in that the disengagement/re-engagement means comprise a compression spring (47) and/or an electromagnet (49).

4. The winch device according to claim 1, characterized in that the disengagement/re-engagement means comprise a disengagement finger (43) attached to the pawl.

5. The winch device according to claim 1, characterized in that each roller (20) cooperates with an associated radial slot (31) made in the drive wheel and an associated curved slot 11 made in the ratchet wheel (10a).

6. The winch device according to claim 1, characterized in that in the centrifugal position, the rollers (20) are arranged to press and roll on the disengagement finger (43), so as to tilt the latter, thus disengaging the ratchet (40) from the ratchet wheel.

7. The winch device according to claim 1, characterized in that the drive means (3) is a motor driving the drum (21) via a gearbox (4)

8. The winch device according to claim 1, characterized in that the pawl is a tilting plate.

9. The winch device according to claim 1, characterized in that it further comprises a compensation means located at a free end of the strap (2).

10. The winch device according to claim 7, characterized in that it comprises a control and drive unit of the motor (3) arranged to synchronously drive a second winch device.
